(19) United States
(12) Patent Application Publication
(10) Pub. No.: US 2004/0101392 A1
(43) Pub. Date: May 27, 2004

(54) Forklift trucks

(76) Inventor: Peter Anthony Drake, Louth (IE)

Correspondence Address: JACOBSON HOLMAN PLLC, 400 SEVENTH STREET N.W., SUITE 600, WASHINGTON, DC, 20004, US

(21) Appl. No.: 10/655,590

(22) Filed: Sep. 5, 2003

(30) Foreign Application Priority Data
Sep. 6, 2002 (IE) 2002/0724

(51) Int. Cl. B66F 1/00

(52) U.S. Cl. 414/664

(57) ABSTRACT

A forklift for mounting on a carrier vehicle which has a two-part upright mast and a telescopic boom substantially orthogonal to the mast slidable up and down the mast to move a fork carrier on the boom in both a horizontal and a vertical direction. Retractable wheels may be provided to support forks on a loading bay floor or truck chassis.

### INTRODUCTION

The present invention relates to a forklift for mounting on the rear of a carrying vehicle of the type comprising a U-shaped chassis having a rear leg bridged by a pair of forwardly projecting side legs, ground engaging wheels, a driver station mounted on one chassis leg, a motor drive mounted on the other chassis leg and forks mounted on a mast assembly located between the side legs of the chassis. The invention relates particularly to the mast assembly.

### BACKGROUND OF THE INVENTION

Such forklift trucks are often referred to as piggy-back forklift trucks and many constructions of such forklift trucks have been sold under the Trade Mark MOUNTY. Very often, they comprise a pair of front wheels and a rear steering wheel. However, equally well, two rear steering wheels are often used and in other embodiments, front steering wheels are used.

It is known to provide a forklift of this type in which the mast assembly comprises a mast assembly in the form of a telescopic mast that can be tilted to provide reach for the forklift. Such a construction of forklift is the telescopic boom forklift and is described in European Patent Specification No. 0 701 963 (Manitou). There are, however, certain problems with such a telescopic boom forklift which, while it allows extended reach for the forks of the forklift to engage a load, it has the disadvantage that as the height of the platform supporting load increases, it becomes increasingly difficult for the telescopic forklift to reach sufficiently far across the platform or vehicle from which the load is being removed or placed on. Obviously, the further the load is spaced-apart from the chassis, the less weight can be carried without causing the forklift to become unstable.

### OBJECTS OF THE INVENTION

The present invention is directed towards providing an improved construction of such a forklift which will overcome these problems.

### SUMMARY OF THE INVENTION

The invention provides a forklift for mounting on the rear of a carrying vehicle of the type comprising a U-shaped chassis comprising a rear leg bridged by a pair of forwardly projecting side legs. A driver station is mounted on one of the side legs and a motorised drive on the other side leg and there are ground engaging wheels, generally one wheel towards the front of each side leg and one rear wheel on the rear leg. An upright mast is mounted on the chassis between the side legs and there is means for moving the mast back and forth between the side leg towards and away from the rear leg. A telescopic boom is slidably mounted on the mast to project substantially orthogonal to the mast. There are also provided means for moving the boom up and down the mast. A fork carrier is generally mounted on the free end of the boom and lifting forks are then mounted on the front carrier. Finally, there are means for extending or reducing the length of boom to move the fork carrier towards and away from the mast.

By providing this arrangement, it is possible to move the load back and forth across a platform, without tipping the forklift. Generally, the mast is mounted on a support frame and there is a pivot mounting between the mast and the support frame, and a tilting ram is connected to the support frame and the mast to tilt the mast on the support frame. The support frame carries rollers to engage in sockets or slots in each side leg. A frame moving ram is connected between the rear leg and the support frame to move the mast back and forth between the side legs.

Generally, the mast is a two-part telescopic mast and comprises a lower inner portion and an upper outer portion embracing the lower inner portion. An actuating ram is housed within the inner portion and connected between the two portions. A pair of pulleys, namely an upper pulley and a lower pulley, is mounted on the outer portion adjacent each end and a pair of drive chains is connected to a mounting bracket secured on the outer portion intermediate its ends, one of the chains being led across one of the pulleys and secured to the boom and the other chain being led across the other pulley and secured to the boom.

In another embodiment, there is provided, rather than two drive chains, an endless drive chain connected again to the mounting bracket and led across each of the pulleys and secured to the boom. The boom will generally be mounted on a sleeve and preferably, adjacent the free end of the boom, there are ground engaging wheels to support the boom on, for example, a platform.

The main advantage of the present invention is that the arrangement of raising and lowering the boom, while also extending the telescopic mast with both operations being carried out synchronously, is particularly advantageous with a piggy-back forklift because the minimum height extension of the mast is provided as the forks are raised and/or extended.

### BRIEF DESCRIPTION OF THE DRAWINGS

The invention will be more clearly understood from the following description of some embodiments thereof, given by way of example only, with reference to the accompanying drawings, in which:—

FIG. 1 is a perspective view of a forklift according to the invention,

FIG. 2 is a side view of the forklift,

FIG. 3 is a front view of the forklift,

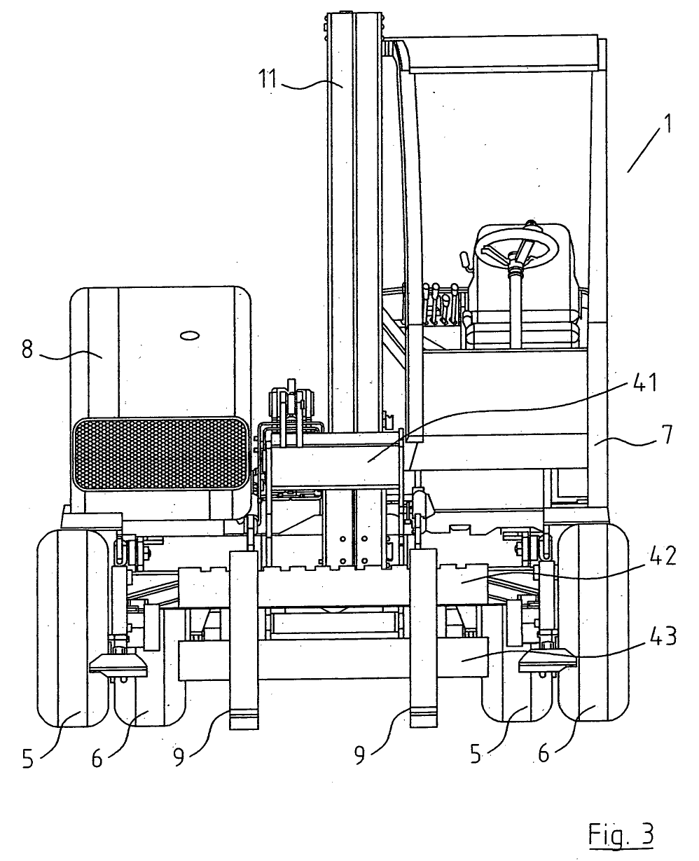

FIG. 4 is a perspective view of a mast assembly according to the invention,

FIG. 5 is a side cut-away view of the mast assembly,

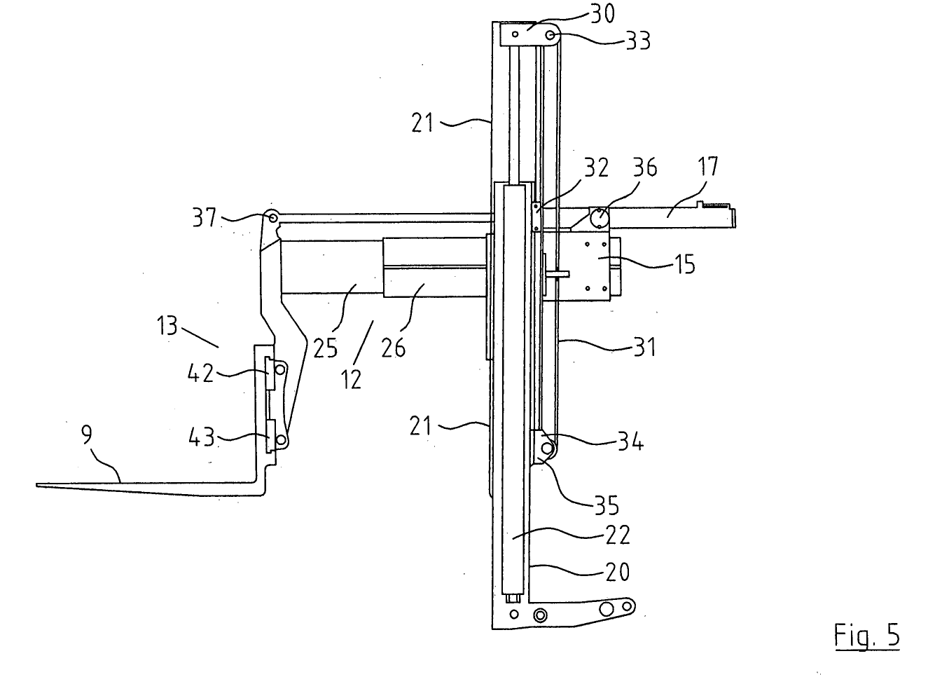

FIG. 6 is an enlarged perspective view of the rear of portion of the mast assembly;

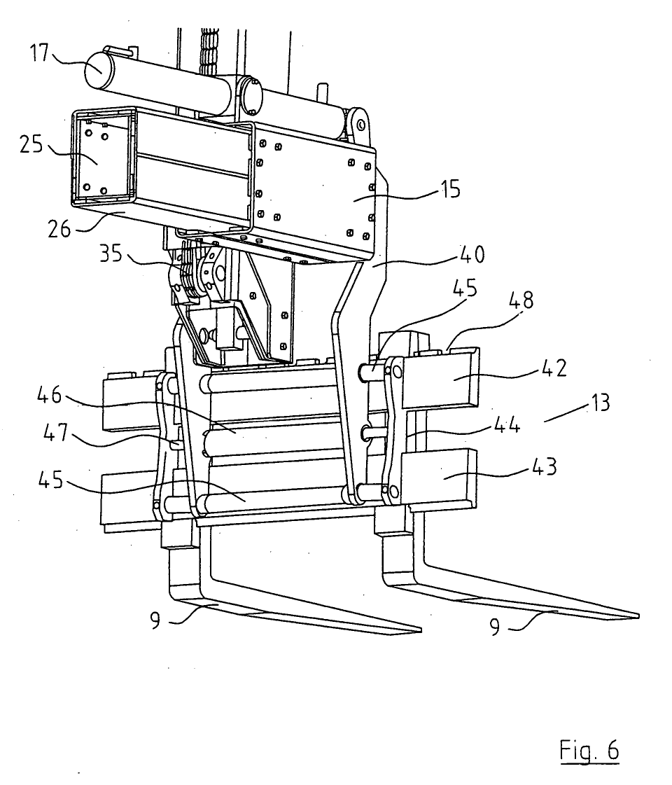

FIG. 7 is a perspective view showing the forklift loading a trailer,

FIG. 8 is a side view of the forklift loading the trailer,

FIG. 9 is a perspective view of another construction of forklift according to the invention, and

FIG. 10 is a side view of the forklift of FIG. 9.

### DETAILED DESCRIPTION OF THE PREFERRED EMBODIMENTS

Referring to the drawings, there is provided a forklift, indicated generally by the reference numeral 1, for mounting on the rear of a carrier vehicle. Neither the carrier vehicle or the means for mounting the forklift 1 on it are illustrated as they have no relevance to this description. The forklift 1 comprises a U-shaped chassis, indicated generally by the reference numeral 2, having a rear leg 3 bridged by a pair of forwardly projecting side legs 4. The chassis 2 is mounted on ground engaging wheels, namely, front wheels 5 and rear wheels 6. A driver station 7 is mounted on one side leg 4 and a motor drive 8 is mounted on the other side leg 4. The driver station has a conventional steering wheel and operating equipment. Similarly, the motor drive 8 is again of conventional construction.

Forks 9 are mounted on a mast assembly, indicated generally by the reference numeral 10, between the side legs 4. The mast assembly 10 comprises an upright mast 11 carrying a boom, indicated generally by the reference numeral 12, substantially orthogonal thereto. The boom 12 is so mounted to be slidable up and down the mast 11 by means, indicated generally by the reference numeral 16, for raising and lowering the boom 12 on the mast 11. The forks are mounted on a fork carrier, indicated generally by the reference numeral 13, mounted on a free end 14 of the boom 12. Means, indicated generally by the reference numeral 17, are provided for moving the fork carrier 13 towards and away from the mast 11.

The upright mast 11 is a telescopic two-part mast comprising a lower inner portion 20 and an upper outer portion 21. The lower inner portion 20 houses a hydraulic actuating ram 22 connected to a bracket 30 on the upper outer portion 21. An actuating or drive chain 31 is mounted on the interior of the outer portion 21 by a bracket 32 and led over a pulley wheel 33 on the bracket 30 and connected to the sleeve 15 by a connector 34. The chain 31 is then led down to a pulley wheel 35 on the exterior of the lower outer portion 21 and back inside the outer portion 21 to the bracket 32. The chain 31 and ram 22 together form the means 16. The pulley wheels 33 and 35 are idler pulleys.

The boom 12 is also a telescopic boom having an inner section 25 slidable within an outer section 26 which are together mounted within the sleeve 15 and movable relative to the sleeve 15 by the actuating ram 17 which is mounted by a bracket 36 on the sleeve 15 and engages at its other end 31, a bracket 37 on the free end 14 of the inner section 25 of the boom 12.

The free end 14 of the boom 12 carries a pair of depending brackets 40 between a cross member 41 which mounts the fork carrier 13. The fork carrier 13 comprises a pair of transverse fork carrying beams, namely, an upper beam 42 and a lower beam 43 connected together by brackets 44. The upper beam has conventional fork engaging slots 48. The brackets 44 are connected by fork frame guide rods 45 which project through the brackets 40. Thus, the beams 42 and 43 are laterally slidable relative to the boom 12. Mounted between the brackets 40 is a cylinder 46 of a double acting side shift ram having piston rods 47 connected to each bracket 44. Thus, the fork carrier 13 and hence the-forks 9 can be moved laterally with respect to the boom 11.

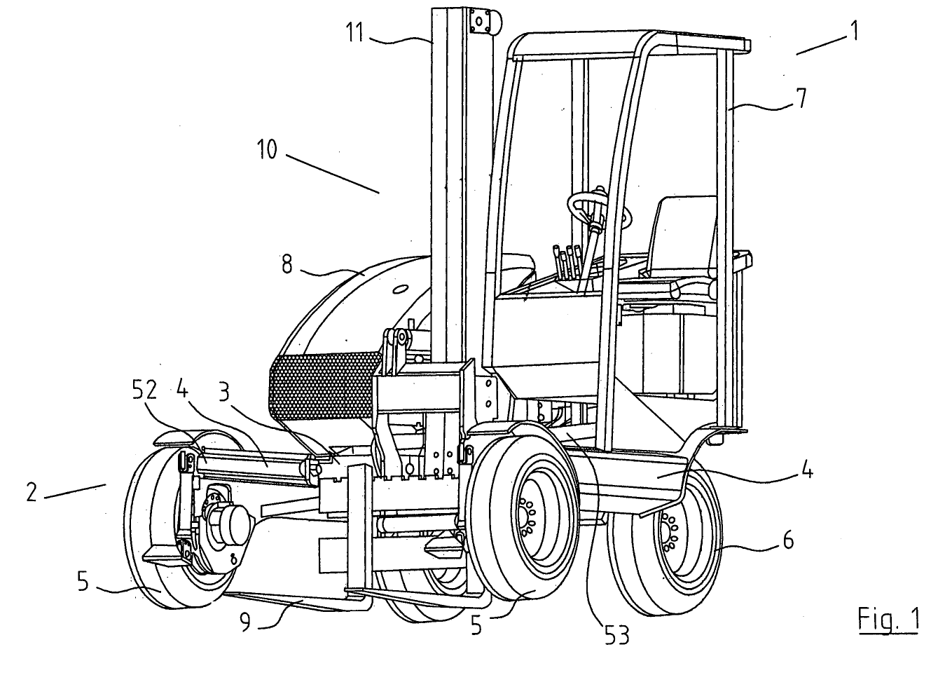

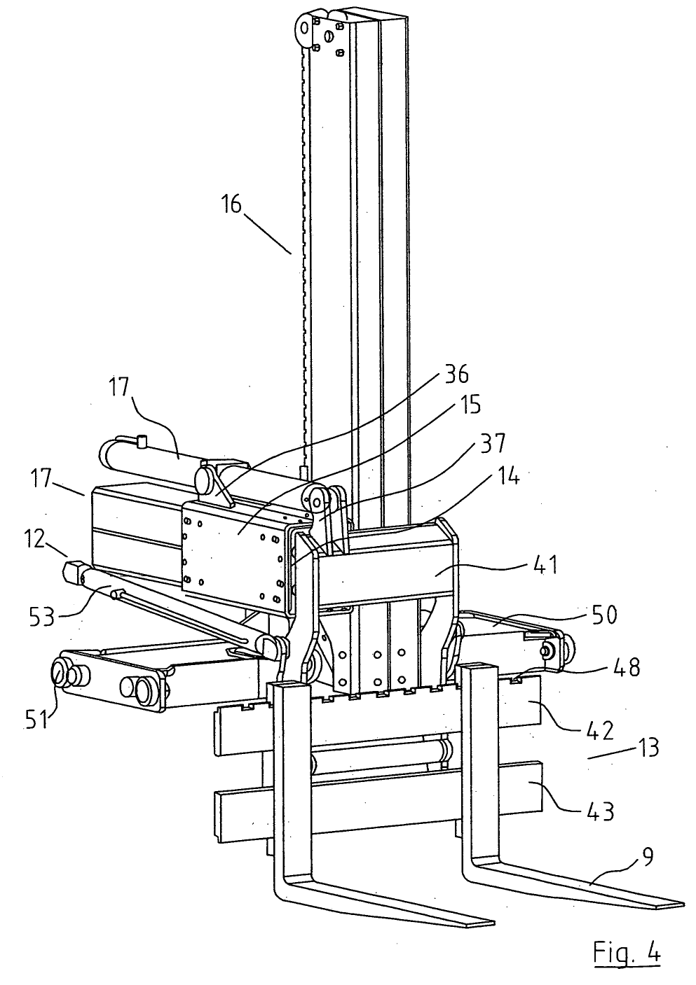

Referring specifically to FIGS. 1, 4 and 8, the mast 11 is illustrated mounted on a rectangular frame 50 carrying rollers 51 which engage within grooves 52 in the side legs 4. A pair of frame moving rams 53 are mounted between the frame 50 and the chassis 2 for movement of the frame 50 towards and away from the chassis 2. A tilting ram 55 is mounted by a bracket 56 on the frame 50 and is also connected to the chassis 2 to allow tilting of the mast 11.

In operation, the forklift 1 is mounted on the rear of a carrying vehicle in conventional manner such as described in our European Patent No. 0 816153.

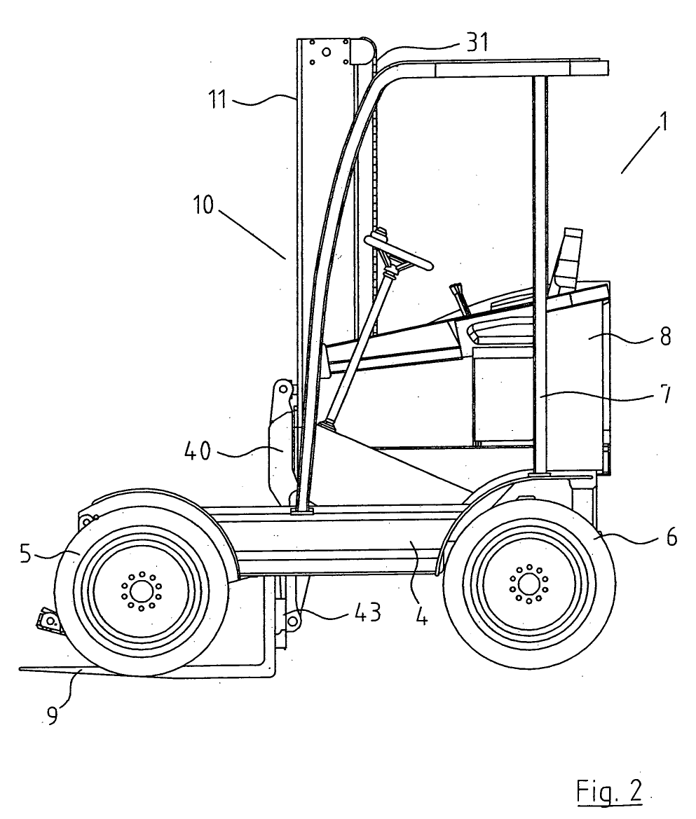

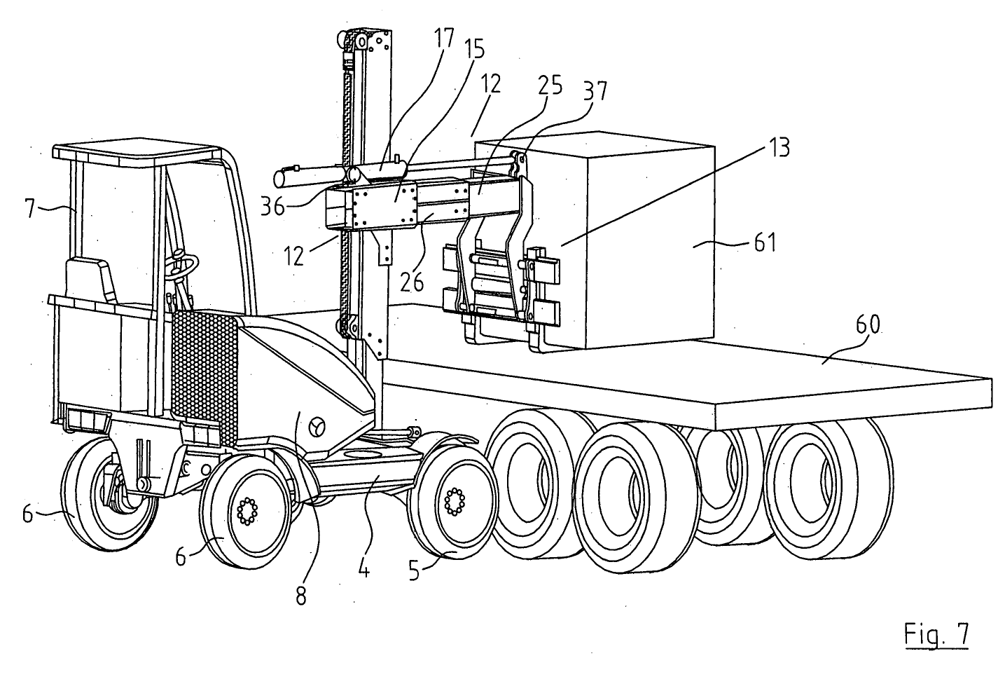

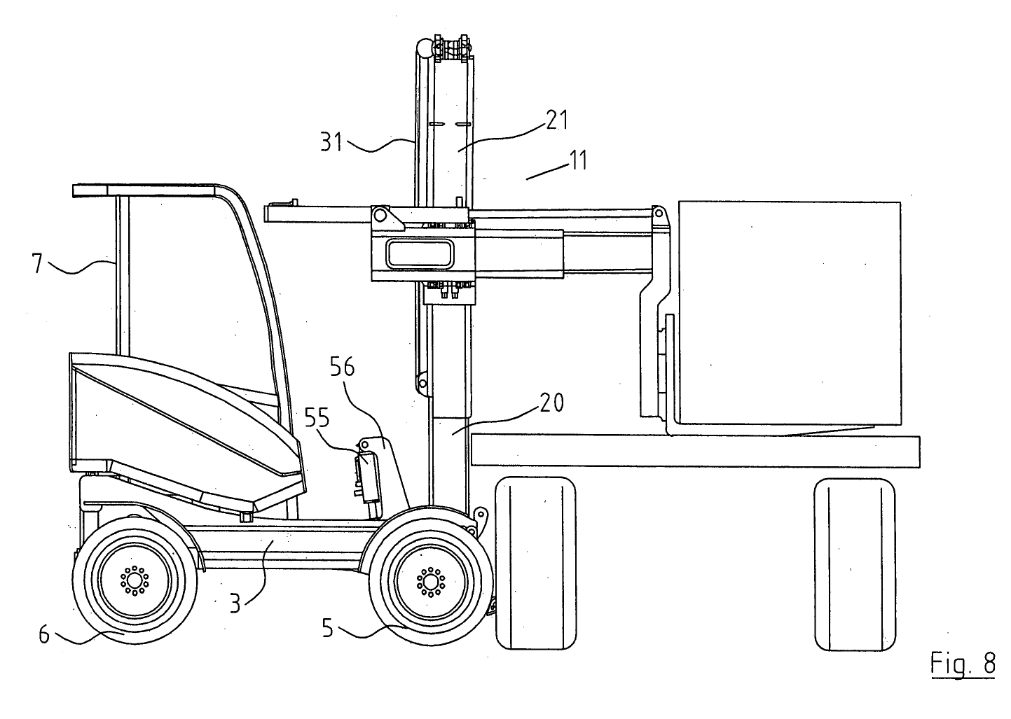

In use and referring specifically to FIGS. 7 and 8, where there is illustrated a trailer 60, onto which is placed a load 61. The forks 9 are illustrated carrying the load 61 in conventional manner. The boom 12 can be moved inwards and outwards by the ram 17 to have the fork carrier 13 assume a position, as illustrated in FIG. 2, close against the mast 11 or in the fully spaced-apart or extended position, as illustrated in FIG. 8.

The mast 11 can be extended or retracted by the actuating ram 22. As the mast 11 is extended, the chain 31 between the pulley 33 and the sleeve 15, shortens and pulls the boom 12 up the mast 11. Simultaneously, the chain between the sleeve 15 and the pulley 35 extends. The reverse motion occurs when the mast 11 is retracted. Similarly, the mast 11 can be moved forwards and backwards by the frame moving ram 53. Thus, loads can be moved across platforms or vehicle bodies in an efficient and easily controlled manner. For very heavy loads, it can be advantageous to have the mast 11 as near as possible to the centre of gravity of the forklift 1. At the same time, the use of the moving support frame can be particularly advantageous where the forklift 1 can only be moved against a platform and not beneath it, where a load is being taken or removed from the platform. There is full, vertical and horizontal control of the movement of the load. This is advantageous as compared to a telescopic boom forklift, which telescopic boom forklift pivots about the vertical to allow the forks engage a load.

Instead of an endless chain, two chains may be used or indeed, wire ropes or any flexible connector.

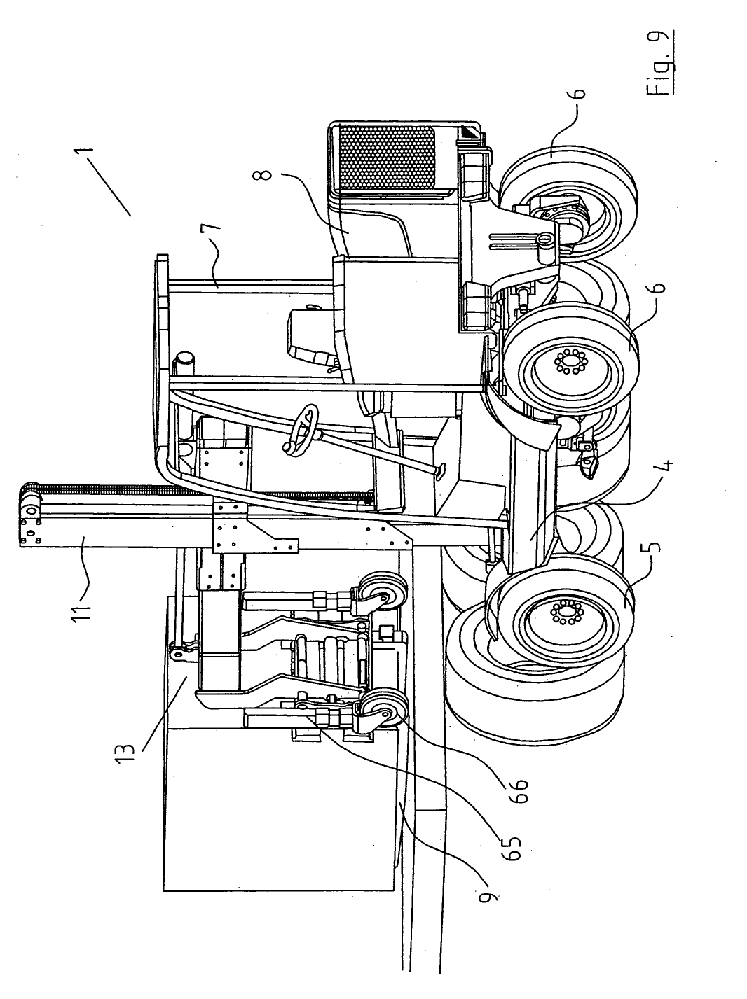

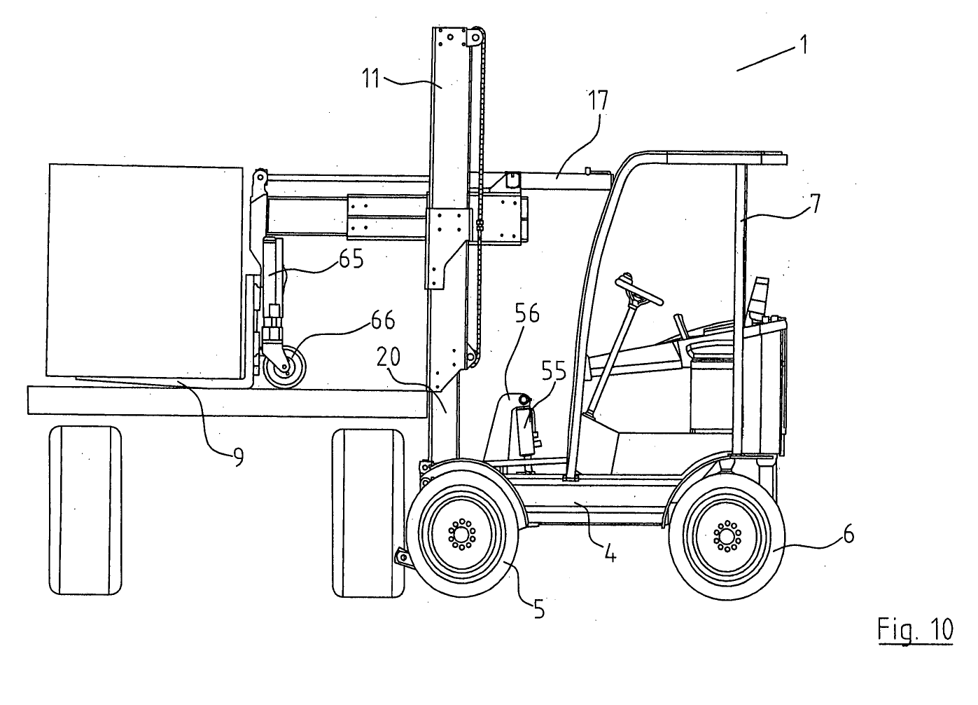

Referring to FIGS. 9 and 10, there is illustrated an alternative construction of forklift, again identified generally by the reference numeral 1, in which parts similar to those described with reference to the previous drawings, are identified by the same reference numerals. In this embodiment, on the fork carrier 13, is mounted, by means of retractable rams 65, a pair of ground engaging wheels 66. In operation, the wheels 66 can be raised and lowered to help support the load. This will also tend to equalise the loading on the forklift and reduce the movement causing the rear wheels of the forklift 1 to raise off the ground. Suitable controls can be provided to raise and lower the wheels 66. It is envisaged that instead of being mounted, as illustrated, with the rams outside the fork carrier, preferably they may be mounted within the frame of the fork carrier.

While in the embodiment described above, the boom is a telescopic boom, it is not necessary to have a telescopic boom and the forks, or more strictly, the fork carrier, could be slidable on a rigid boom. All that is required is that the forks be movable in the x and y axis.

In the specification the terms “comprise, comprises, comprised and comprising” or any variation thereof and the terms “include, includes, included and including” or any variation thereof are considered to be totally interchangeable and they should all be afforded the widest possible interpretation and vice versa.

The invention is not limited to the embodiment hereinbefore described, but may be varied in both construction and detail within the scope of the appended claims.

1. A forklift for mounting on the rear of a carrying vehicle comprising:
a U-shaped chassis comprising a rear leg bridged by a pair of forwardly projecting side legs;
ground engaging wheels mounted on the chassis;
a driver station mounted on one of the side legs;
a motorised drive mounted on the other side leg;
an upright mast mounted on the chassis between the side legs;
means for moving the mast back and forth between the side legs towards and away from the rear leg;
a telescopic boom slidably mounted on the mast to project substantially orthogonal to the mast;
means for moving the boom up and down the mast;
a fork carrier mounted on a free end of the boom;
lifting forks mounted on the fork carrier; and
means for extending or reducing the length of the boom to move the fork carrier towards and away from the mast.

2. A forklift as recited in claim 1, in which the means for moving the mast between the side legs comprises:
a support frame;
a pivot mounting between the mast and the support frame;
a tilting ram connecting the support frame and the mast;
rollers mounting the support frame in each side leg; and
a frame moving ram connected between the rear leg and the support frame.

3. A forklift as recited in claim 1, in which the mast is a two part telescopic mast and comprises:
a lower inner portion and an upper outer portion embracing the lower inner portion; and
an actuating ram housed within the inner portion and connected between the two portions.

4. A forklift as recited in claim 1, in which the mast is a two part telescopic mast and comprises:
a lower inner portion and an upper outer portion embracing the, lower inner portion;
an actuating ram housed within the inner portion and connected between the two portions;
a pair of pulleys, namely an upper pulley and a lower pulley, mounted on the outer portion adjacent each end; and
a pair of drive chains connected to a mounting bracket secured on the outer portion intermediate its ends, one of the chains being led across one of the pulleys and secured to the boom and the other chain being led across the other pulley and secured to the boom.

5. A forklift as recited in claim 1, in which the mast is a two part telescopic mast and comprises:
a lower inner portion and an upper outer portion embracing the lower inner portion;
an actuating ram housed within the inner portion and connected between the two portions;
a pair of pulleys, namely an upper pulley and a lower pulley, mounted on the outer portion adjacent each end; and
an endless drive chain connected to a mounting bracket secured on the outer portion intermediate its ends and led across each of the pulleys and secured to the boom.

6. A forklift as recited in claim 1, in which the boom is slidably mounted by a sleeve on the mast and an actuating ram is connected between the sleeve and the free end of the boom.

7. A forklift as recited in claim 1, in which there is mounted, adjacent the free end of the boom, a ground engaging wheel.

8. A forklift as recited in claim 1, in which a pair of laterally spaced-apart ground engaging wheels are mounted adjacent the free end of the boom, each by a retractable ram, to raise and lower the wheel above and below the forks.

9. A forklift for mounting on the rear of a carrying vehicle comprising:
a U-shaped chassis comprising a rear leg bridged by a pair of forwardly projecting side legs;
three ground engaging wheels mounted on the chassis;
a driver station mounted on one of the side legs;
a motorised drive mounted on the other side leg;
an upright telescopic mast mounted on the chassis between the side legs;
means for moving the mast back and forth between the side legs towards and away from the rear leg;
a telescopic boom slidably mounted on the mast to project substantially orthogonal to the mast;
means for moving the boom up and down the mast;
a fork carrier mounted on a free end of the boom;
lifting forks mounted on the fork carrier; and
means for extending or reducing the length of the boom to move the fork carrier towards and away from the mast.

10. A forklift as recited in claim 9, in which the means for moving the mast between the side legs comprises:
a support frame;
a pivot mounting between the mast and the support frame;
a tilting ram connecting the support frame and the mast;
rollers mounting the support frame in each side leg; and
a frame moving ram connected between the rear leg and the support frame.

11. A forklift as recited in claim 9, in which the mast is a two part telescopic mast and comprises:
a lower inner portion and an upper outer portion embracing the lower inner portion; and
an actuating ram housed within the inner portion and connected between the two portions.

12. A forklift as recited in claim 9, in which the mast is a two part telescopic mast and comprises:
a lower inner portion and an upper outer portion embracing the lower inner portion;
an actuating ram housed within the inner portion and connected between the two portions;
a pair of pulleys, namely an upper pulley and a lower pulley, mounted on the outer portion adjacent each end; and
a pair of drive chains connected to a mounting bracket secured on the outer portion intermediate its ends, one of the chains being led across one of the pulleys and secured to the boom and the other chain being led across the other pulley and secured to the boom.

13. A forklift as recited in claim 9, in which the mast is a two part telescopic mast and comprises:
a lower inner portion and an upper outer portion embracing the lower inner portion;
an actuating ram housed within the inner portion and connected between the two portions;
a pair of pulleys, namely an upper pulley and a lower pulley, mounted on the outer portion adjacent each end; and
an endless drive chain connected to a mounting bracket secured on the outer portion intermediate its ends and led across each of the pulleys and secured to the boom.

14. A forklift as recited in claim 9, in which the boom is slidably mounted by a sleeve on the mast and an actuating ram is connected between the sleeve and the free end of the boom.

15. A forklift as recited in claim 9, in which there is mounted, adjacent the free end of the boom, a ground engaging wheel.

16. A forklift as recited in claim 9, in which a pair of laterally spaced-apart ground engaging wheels are mounted adjacent the free end of the boom, each by a retractable ram, to raise and lower the wheel above and below the forks.

17. A forklift for mounting on the rear of a carrying vehicle comprising:
a U-shaped chassis comprising a rear leg bridged by a pair of forwardly projecting side legs;
three ground engaging wheels mounted on the chassis;
a driver station mounted on one of the side legs;
a motorised drive mounted on the other side leg;
a support frame;
an upright telescopic mast on the support frame;
a pivot mounting connecting the mast to the support frame;
a tilting frame connecting the support frame and the mast;
rollers mounting the support frame in each side leg;
a frame moving ram connected between the rear leg and the support frame for moving the mast back and forth between the side legs towards and away from the rear leg;
a telescopic boom slidably mounted on the mast to project substantially orthogonal to the mast;
means for moving the boom up and down the mast;
a fork carrier mounted on a free end of the boom;
lifting forks mounted on the fork carrier; and
means for extending or reducing the length of the boom to move the fork carrier towards and away from the mast.

18. A forklift as recited in claim 17, in which the mast is a two part telescopic mast and comprises:
a lower inner portion and an upper outer portion embracing the lower inner portion; and
an actuating ram housed within the inner portion and connected between the two portions.

19. A forklift as recited in claim 17, in which the mast is a two part telescopic mast and comprises:
a lower inner portion and an upper outer portion embracing the lower inner portion;
an actuating ram housed within the inner portion and connected between the two portions;
a pair of pulleys, namely an upper pulley and a lower pulley, mounted on the outer portion adjacent each end; and
a pair of drive chains connected to a mounting bracket secured on the outer portion intermediate its ends, one of the chains being led across one of the pulleys and secured to the boom and the other chain being led across the other pulley and secured to the boom.

20. A forklift as recited in claim 17, in which the mast is a two part telescopic mast and comprises:
a lower inner portion and an upper outer portion embracing the lower inner portion;
an actuating ram housed within the inner portion and connected between the two portions;
a pair of pulleys; namely an upper pulley and a lower pulley, mounted on the outer portion adjacent each end; and
an endless drive chain connected to a mounting bracket secured on the outer portion intermediate its ends and led across each of the pulleys and secured to the boom.

21. A forklift as recited in claim 17, in which the boom is slidably mounted by a sleeve on the mast and an actuating ram is connected between the sleeve and the free end of the boom.

22. A forklift as recited in claim 17, in which there is mounted, adjacent the free end of the boom, a ground engaging wheel.

23. A forklift as recited in claim 17, in which a pair of laterally spaced-apart ground engaging wheels are mounted adjacent the free end of the boom, each by a retractable ram, to raise and lower the wheel above and below the forks.
